(19) United States
(12) Patent Application Publication
(10) Pub. No.: US 2013/0202753 A1
(43) Pub. Date: Aug. 8, 2013

(54) SYSTEMS AND METHODS FOR MEAT BONDING

(71) Applicant: Oberto Sausage Company, Kent, WA (US)

(72) Inventors: Richard Meyer, Kent, WA (US); Tiffany Fegurgur, Kent, WA (US)

(21) Appl. No.: 13/647,288

(22) Filed: Oct. 8, 2012

Related U.S. Application Data
(60) Provisional application No. 61/545,082, filed on Oct. 7, 2011.

(51) Int. Cl. A23L 1/00

(52) U.S. Cl. CPC A23L 1/0017
USPC 426/274

(57) ABSTRACT

Systems and methods for forming raw meat structures from a plurality of meat pieces. Meat pieces of diverse shape, size, and quality are coated with a bonding agent such as a transglutaminase and then pressurized at low temperature. The pressure, temperature and bonding agent cause the meat pieces to form a composite, uncooked meat structure that is suitable for cutting, extruding, shaping, and other meat processing.

### CROSS-REFERENCE TO RELATED APPLICATION(S)

This patent application claims the benefit of U.S. Provisional Patent Application Ser. No. 61/545,082, filed on Oct. 7, 2011, and entitled “SYSTEMS AND METHODS FOR MEAT BONDING,” the disclosure of which is incorporated herein by reference in its entirety.

### TECHNICAL FIELD

The present technology is related to systems and methods for bonding pieces of meat into a mostly or completely raw composite meat structure with a desirable texture.

### BACKGROUND

Meat products such as jerky can be made in many ways. Many conventional methods for producing jerky and other processed meat products involve grinding and extruding the meat, resulting in a final product with a less-than optimal texture. These methods usually involve at least partially cooking the meat or otherwise denaturing the proteins before finalizing the jerky, which also produces an unsatisfactory result. Some methods for processing meat involve extruding meat through a nozzle into a desired shape. In order to fit them through the nozzle, the meat pieces are generally small, making the overall texture of the meat less like unprocessed meat. Still other methods of making jerky and other processed meat product, including slicing whole pieces of meat, are generally too expensive and incur much waste. There is accordingly a need for an efficient way of making jerky and other processed meat products.

### BRIEF DESCRIPTION OF THE DRAWINGS

FIG. 1 is a flow chart of a method for forming a composite meat structure according to embodiments of the disclosed technology.

FIG. 2 is a chart of pressure and time associated with a pressure cycle according to embodiments of the disclosed technology.

FIG. 3 is a chart of a method for further processing of the meat structure after the pressure cycle according to embodiments of the disclosed technology.

### DETAILED DESCRIPTION

The present technology is directed to a method for forming a composite meat structure by applying a bonding agent to meat pieces, and fusing the meat pieces into a cohesive gel-like meat structure by activating the bonding agent under applied pressure of between 20,000 and 100,000 psi for no more than two minutes without cooking the meat.

The present technology is also directed to a method for making a composite meat structure by applying a bonding agent to meat pieces, placing the meat pieces into a pressure vessel, and fusing the meat pieces into an uncooked composite meat structure by pressurizing the meat pieces within the pressure vessel. The method can also include maintaining a temperature within the pressure vessel below a threshold temperature at which proteins of the meat pieces substantially denature. The method can further include seasoning the meat structure by applying seasoning to a surface of the meat pieces with the bonding agent, or by injecting seasoning into at least some of the meat pieces, either before or after fusing the meat pieces.

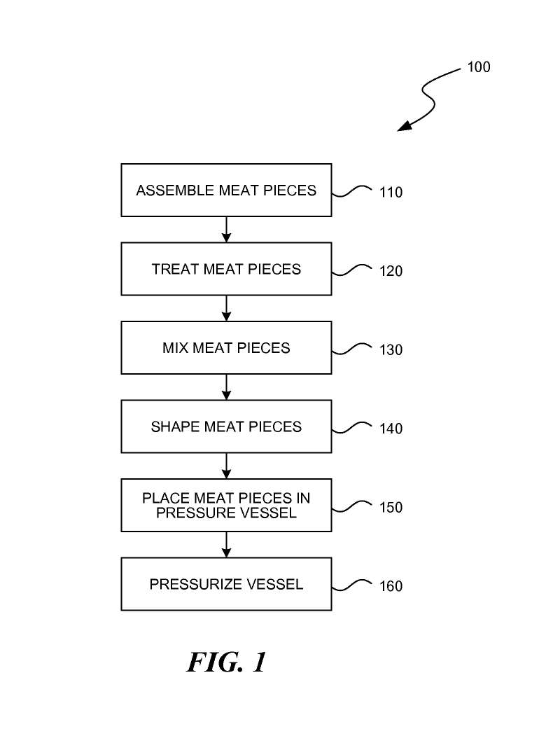

Specific details of several embodiments of the present systems and methods are described below. A person skilled in the relevant art will understand that the new technology may have additional embodiments and that the new technology may be practiced without several of the details of the embodiments described below with reference to FIGS. 1-3. The systems and methods of the present disclosure are generally directed to forming an uncooked composite meat structure from smaller meat scraps and other types of meat pieces without cooking the meat and without substantially denaturing the proteins of the meat. The end result is a composite piece of meat that resembles a regular cut of meat. The composite meat structure is at least partially raw and can be cut, processed, and treated like a regular cut of meat. Forming the composite meat structure from scraps and other available meat pieces avoids waste and lowers overall cost of production. In addition, the meat pieces used to form the composite meat structure can include various types of meat such as white meat, red meat and seafood in any suitable combination.

FIG. 1 is a flow chart 100 of a method for forming a composite meat structure according to embodiments of the present disclosure. The assembly of meat pieces (block 110) can include scraps left over from other meat processes, or simply small pieces of meat that will be combined into a larger composite meat structure. The meat pieces can be homogeneous (e.g., all chicken, all pork, all beef, all seafood. Etc.), or they can be any suitable mixture of meat types, qualities, and varieties in any suitable quantity or ratio. The meat pieces are then treated (block 120) by, for example, cutting, cleaning, and otherwise preparing the meat pieces. In addition, a bonding agent can be applied to the meat pieces. A suitable bonding agent, for example, is transglutaminase, several phosphates, gelatin, egg whites, starches, glutaraldehyde, glutens, carrageenan and virtually any other suitable bonding agent that is known in the art. The bonding agent can be applied to the meat in a water bath or in any other suitable way.

In some embodiments, the bonding agent can draw salt soluble proteins, such as short-chain proteins, to the surface of the meat pieces so that when the meat pieces are brought into contact with one another the salt soluble proteins bond the meat pieces together as will be described in greater detail herein. Different bonding agents can bond the meat pieces together in different ways, according to the type of bonding agent and perhaps depending on the reaction between the various meat types and the bonding agents of a particular application. Step 130 is to mix the meat pieces by paddle-stirring or another suitable mixing method. For example, the meat pieces can be stirred or otherwise mixed for approximately 15 minutes to help the salt soluble proteins move to the surface of the meat pieces. This process can be performed while the meat pieces are in a vacuum.

The method further includes shaping (block 140) the meat pieces. In some embodiments the desired meat structure will have a certain shape. For example, scraps of meat can be assembled and formed into a shape that resembles a chicken breast or a cut of steak or any other meat cut. Other fanciful shapes, such as letters, designs, and characters, can also be achieved. In some embodiments, the meat pieces can be vacuum-packed into a casing having a desired shape. In other embodiments the meat pieces can be put into a mold (with or without a casing) having a defined shape.

After shaping the meat pieces, the method includes placing the meat pieces (block 150) in a pressurized vessel. In some embodiments the pressurized vessel can contain a suitable fluid such as water. The vessel is then pressurized (block 160). The step of pressurizing the vessel can be done for a specific duration of time at a specific pressure and at a certain temperature that allows the meat pieces and the bonding agent to bond or fuse together forming the composite meat structure.

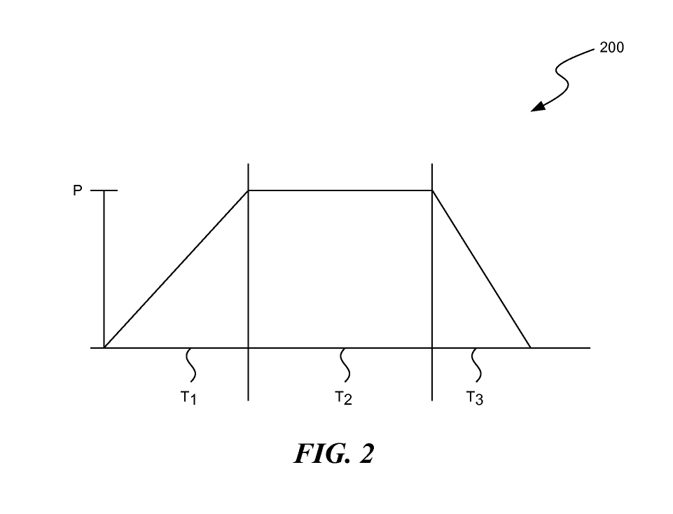

FIG. 2 is a chart 200 of time and pressure that shows further details for pressurizing the vessel (block 160) shown in FIG. 1, according to embodiments of the present disclosure. There are three time periods: T1, a pressure ramp-up time, T2, a steady-state pressure period during which the pressure P is maintained substantially constant, and T3, a pressure ramp-down period. In some embodiments T1 and T3 are very brief. In other embodiments T1 and T3 are more sustained, depending on the capabilities of the equipment and the desired effect on the product. In some embodiments, T2 is between approximately one second and 10 minutes. The chart 200 shows a single pressure cycle; however, in other embodiments, multiple pressure cycles of varying pressures and durations can be used. For example, the pressure cycle for a given meat product can be a first pressure cycle followed by a second pressure cycle reaching a higher pressure P than the first pressure cycle.

The pressure in the pressure vessel causes the meat pieces, which are assisted by the bonding agent, to bond together into the composite meat structure. In some embodiments, some of the proteins at the surface of the meat pieces are selectively denatured in order to bond the meat pieces. In other embodiments, the bonding agent forms the bond without denaturing or with minimal denaturing. In general, proteins that denature to form the bond are short-chain proteins, while the long-chain proteins are not denatured and remain uncooked. The temperature of the pressure vessel can be maintained below a threshold temperature at which proteins in the meat pieces begin to substantially denature to bond the meat without cooking it. In some embodiments the initial temperature of the pressure vessel is between zero and 10 degrees Celsius and is maintained below a certain temperature throughout the pressure cycle. As the pressure is applied to the meat pieces in the pressure vessel, the adiabatic temperature may rise at a rate of approximately three degrees Celsius per 10,000 psi. Accordingly, in some embodiments if the initial pressure is approximately zero degrees Celsius, a pressure cycle of up to 100,000 psi will raise the temperature up to around 30 degrees Celsius, which is lower than a temperature at which meat proteins will denature. The effect of maintaining this pressure and temperature is to not cook the meat pieces as the pressure is applied. In some embodiments the temperature can be actively reduced or chilled to further avoid denaturing proteins or cooking the meat, or even to permit higher pressures to be used, such as beyond 100,000 psi.

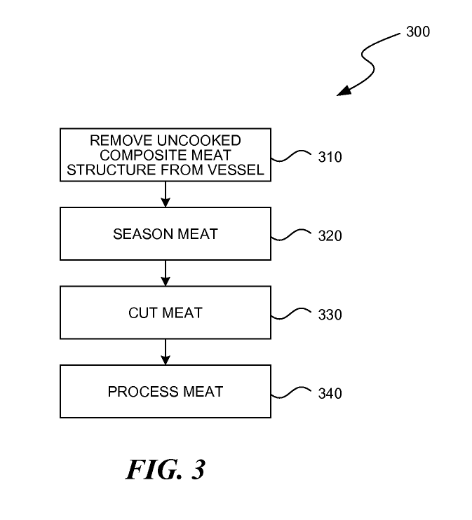

FIG. 3 is a flow chart 300 of a method for processing a composite meat structure according to embodiments of the present disclosure. The resultant meat product is an uncooked composite meat structure that has a “gel-like” texture which means that the meat resembles a regular cut of meat. The resultant meat product can be removed from the pressure vessel (block 310). In some embodiments the composite meat structure can be firm enough to stand unsupported on a surface. After removing the composite meat structure from the pressure vessel, and after a brief, optional resting period, the meat structure can be seasoned (block 320). In some embodiments, the meat can be tacky and can take a powder coating, similar to raw meat. In other embodiments, the seasoning can be injected into the meat structure with needles, basters, or other appropriate tools. Sauces, salts, preservatives, additives (e.g., nuts, fruit, etc), coloring, and any other suitable treatment substance can be applied to the composite meat structure. The composite meat structure can be cut (block 330) and processed (block 340) as desired. For example, the composite meat structure can be made into jerky, cooked, packaged into lunch meat, frozen, or prepared with other meat product.

From the foregoing, it will be appreciated that specific embodiments of the technology have been described herein for purposes of illustration, but that various modifications may be made without deviating from the disclosure. Certain aspects of the new technology described in the context of particular embodiments may be combined or eliminated in other embodiments. For example, the pressure cycle and temperature of the pressure vessel can be varied according to a given application. Additionally, while advantages associated with certain embodiments of the new technology have been described in the context of those embodiments, other embodiments may also exhibit such advantages, but not all of the embodiments within the scope of the technology necessarily exhibit such advantages. Accordingly, the disclosure and associated technology can encompass other embodiments not expressly shown or described herein.

I/We claim:

1. A method for fusing meat pieces, comprising:
applying a bonding agent to the meat pieces; and
fusing the meat pieces into a cohesive gel-like meat structure by activating the bonding agent under an applied pressure of between 20,000 and 100,000 psi for no more than two minutes without cooking the meat pieces.

2. The method of claim 1 wherein applying between 20,000 and 100,000 psi of pressure to the meat pieces comprises applying approximately 60,000 psi of pressure to the meat pieces.

3. The method of claim 1 wherein fusing the meat pieces comprises selectively denaturing proteins of the meat pieces.

4. The method of claim 3 wherein selectively denaturing the proteins comprises denaturing short-chain proteins without denaturing long-chain proteins.

5. The method of claim 3 wherein selectively denaturing the proteins comprises denaturing the proteins at a surface of the meat pieces to form a bond between meat pieces without denaturing the proteins within the meat pieces.

6. The method of claim 1 wherein fusing the meat pieces comprises fusing meat pieces from diverse sources.

7. The method of claim 6 wherein fusing the meat pieces from diverse sources comprises fusing at least two of chicken, beef, pork and seafood meat pieces.

8. The method of claim 1 wherein applying the bonding agent to the meat pieces comprises bringing salt-soluble proteins to a surface of the meat pieces, and wherein fusing the meat pieces comprises bonding the salt-soluble proteins together.

9. The method of claim 1 wherein applying the pressure to the meat pieces for no more than two minutes comprises applying the pressure to the meat pieces for approximately one second.

10. The method of claim 1 wherein fusing the meat pieces into the cohesive gel-like meat structure comprises forming a cuttable meat structure.

11. The method of claim 1 wherein applying the pressure to the meat comprises submerging the meat pieces in water and pressurizing the water.

12. The method of claim 1 wherein applying the bonding agent to the meat pieces comprises applying at least one of transglutimanase, gluteraldehyde, carragenan, enzymes, phosphates, gelatin, egg whites, and starches to the meat pieces.

13. The method of claim 1, further comprising applying seasoning to the meat pieces after fusing the meat pieces.

14. The method of claim 1, further comprising applying seasoning to the meat pieces before fusing the meat pieces.

15. The method of claim 1, further comprising maintaining the meat pieces below approximately 25° Celsius while fusing the meat pieces.

16. The method of claim 1, further comprising making at least one of jerky, simulated shaped meats and lunch meats from the meat structure.

17. A method of making a composite meat structure, the method comprising:
applying a bonding agent to meat pieces;
placing the meat pieces into a pressure vessel;
fusing the meat pieces into an uncooked composite meat structure by pressurizing the meat pieces within the pressure vessel; and
maintaining a temperature within the pressure vessel below a threshold temperature at which proteins of the meat pieces substantially denature.

18. The method of claim 17, further comprising placing the meat pieces into a casing having a desired shape, wherein fusing the meat pieces into the uncooked composite meat structure comprises fusing the meat pieces into the uncooked composite meat structure having the desired shape.

19. The method of claim 18 wherein placing the meat pieces into a casing comprises vacuum-packing the meat pieces into the casing.

20. The method of claim 17 wherein placing the meat pieces into the pressure vessel comprises placing the meat pieces into a holding vessel having a shape, the holding vessel being positioned within the pressure vessel, and wherein fusing the meat pieces into the uncooked composite meat structure comprises fusing the meat pieces into a shaped uncooked composite meat structure having the shape of the holding vessel.

21. The method of claim 17, further comprising seasoning the composite meat structure by at least one of:
applying seasoning to a surface of the meat pieces with the bonding agent;
injecting seasoning into at least some of the meat pieces;
applying seasoning to a surface of the composite meat structure after fusing the meat pieces; and
injecting the composite meat structure with seasoning after fusing the meat pieces.

22. The method of claim 17 wherein pressurizing the meat pieces comprises applying between approximately 20,000 psi and 100,000 psi to the meat pieces.

23. The method of claim 17, further comprising making jerky from the composite meat structure.

24. The method of claim 17 wherein fusing the meat pieces comprises making the composite meat structure firm enough to maintain a desired shape without support.
